(19) United States
(12) Patent Application Publication
(10) Pub. No.: US 2008/0122990 A1
(43) Pub. Date: May 29, 2008

(54) SIMPLIFIED USER INTERFACE ACTIVATED BY SECONDARY REMOTE CONTROL

(75) Inventor: MARK RUMREICH, INDIANAPOLIS, IN (US)

Correspondence Address: SHIMOKAJI & ASSOCIATES, P.C., 8911 RESEARCH DRIVE, IRVINE, CA, 92618, US

(73) Assignee: TTE TECHNOLOGY, INC., INDIANAPOLIS, IN (US)

(21) Appl. No.: 11/566,128

(22) Filed: Dec. 1, 2006

(30) Foreign Application Priority Data
Nov. 27, 2006 (CN) 200610157050.6

(51) Int. Cl. H04N 5/44

(52) U.S. Cl. 348/734; 348/E05.096

(57) ABSTRACT

A television having both a simplified remote control and a full-sized remote control may be designed to allow the user a selection of a simplified user interface or a full user interface, respectively. The television may be manufactured as a single model, thereby obviating the need for multiple television models to cater both to those who desire full control of the television features and to those who desire only basic control of the television features.

### CROSS-REFERENCE TO RELATED APPLICATIONS

This application claims foreign priority under 35 USC 119(a)-(d) to Chinese Patent Application 200610157050.6, filed on Nov. 27, 2006, the disclosure of which is herein incorporated by reference in its entirety.

### BACKGROUND OF THE INVENTION

The present invention relates to a simplified user interface for operating an appliance, such as a television, and more specifically, to a simplified user interface for a television activated by a secondary remote control.

As televisions get increasingly complex, so do their user interfaces. Consumers are presented with menu after menu of options for controlling the picture, sound, parental control, time, preferences and setup variables. Many consumers desire the ability to control every facet of their television's performance and welcome these options. Many other consumers, however, are intimidated and confused by this staggering array of settings, most of which they will never change.

One solution to this problem has been to manufacture alternate product models, some with a complex user interface (catering to the videophile), and others with a simplified user interface. This approach, however, creates the problem of having to support these additional models in the supply chain, stores, catalogs and manufacturing.

Another solution to this problem, as described in European Patent No. 0 737 006, has been to provide the user of the appliance with the option to change a particular menu according to their desires and capabilities. By operating appropriate buttons in an existing menu, the user can then remove the parameters which are not used or inconvenient for them, or can add new parameters which are missing but are important for them. This approach allows a particular menu to be individually matched to the respective requirements and capabilities of the user. This approach, however, requires the user to have a level of menu programming savvy that may not match the capabilities of the particular user.

A further approach, as described in European Patent No. 1 128 531, involves storing a number of menus, with varying degrees of complexity, within the appliance, such as a television. The user may then choose the menu system that is most suited to their requirements. This approach, however, requires the user to know the complexity of the menu system they desire and choose the appropriate menu system from the plurality of menu systems stored in the television.

As can be seen, there is a need for a single television design that may cater to both the videophile, who desires multiple layers of menu and programming options, and to the those who prefer a simplified user interface.

### SUMMARY OF THE INVENTION

In one aspect of the present invention, an appliance comprises a simplified remote control for accessing a simplified user interface of the appliance; and a full-sized remote control for accessing a full user interface of the appliance.

In another aspect of the present invention a system for displaying an appropriate menu system to a user of a television, the system comprises a simplified remote control for accessing a simplified menu system of the television; and a full-sized remote control for accessing a full menu system of the television.

According to a further aspect of the present invention, a method for displaying an appropriate user interface to a user of an appliance, the method comprises determining whether a signal is received from a simplified remote control or from a full-sized remote control; offering the user a simplified user interface when the signal is received from the simplified remote control; and offering the user a full user interface when the signal is received from the full-sized remote control.

These and other features, aspects and advantages of the present invention will become better understood with reference to the following drawings, description and claims.

### BRIEF DESCRIPTION OF THE DRAWINGS

FIG. 1 is a perspective view of an appliance operable by two separate remote controls according to an embodiment of the present invention; and

FIG. 2 is a flow chart showing a method according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The term “appliance” as used herein may refer to any electronic equipment operated by a remote control that allows users to adjust various features. An appliance may include a television, VCR, DVD player/recorder, surround sound system, digital cable systems, a digital television recorder, a video recorder, a television set-top box and the like.

The term “user interface” as used herein may refer to an interface between an appliance and the user in which the user may select and/or adjust certain features of the appliance. Typically, the user interface may be a menu system that allows the user to adjust various features, such as, when the appliance is a television, color, brightness, sound quality, contrast and the like. The user interface may be a “full user interface” which offers the user full access to the controls of the appliance. The user interface may also be a “simplified user interface” wherein only certain basic controls are offered to the user. These basic controls may include channel selection, volume control, sound quality and the like.

The term “full-sized remote control” as used herein may refer to a remote control that may be used to access a full array of features of an appliance, such as a television. “Full-sized” is not meant as a reference to the physical size of the remote control.

The term “simplified remote control” as used herein refers to a remote control that may be used to access a limited number of features and/or basic features of an appliance, such as a television.

Briefly, the present invention provides an appliance design with multiple user interfaces. The selection of a user interface is activated by the use of the corresponding remote control. There may be a simplified user interface which may be accessed using a simplified remote control and there may be a full user interface which may be accessed using a full-sized remote control.

Unlike conventional televisions which may have a user interface, such as a menu system, that is either un-adjustable or that may be adjusted by the user via a series of complex steps on the remote control, the appliances and methods of the present invention may have involve a user interface which may be chosen by selecting the appropriate remote control. In other words, there may be a simplified remote control which may be used to access the simplified user interface and there may be a full-sized remote control which may be used to access the full user interface.

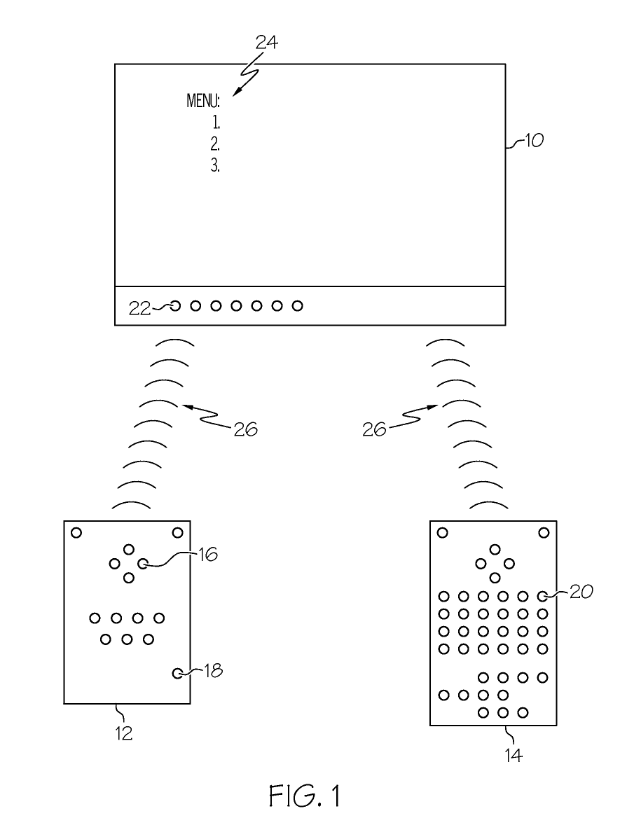

Referring to FIG. 1, there is shown a perspective view of an appliance, such as a television 10, which may be operated by either a full-sized remote control 14 or a simplified remote control 12. A user interface 24, such as a menu, may be activated on the television 10. A full user interface may be activated by using the full-sized remote control 14. A simplified user interface may be activated by using the simplified remote control 12.

The simplified remote control 12 may include buttons 16 to allow a user to access limited settings of the television 10. These limited settings may include channel selection, volume control, sound quality adjustment, picture brightness, picture contrast and the like. The simplified remote control 12 may include a reset button 18 which may reset the television 10 back to preset default settings, such as factory preset settings. The reset button 18 may be useful, for example, when certain settings are adjusted with the full-sized remote control 14 and the user wishes to return to the factory preset settings. The reset button 18 may be recessed within the simplified remote control 12 to prevent accidental activation thereof.

The full-sized remote control 14 may include buttons 20 to allow the user to adjust any user adjustable setting of the television 10. These user adjustable settings may include advanced adjustments such as individual color temperature, resolution, refresh rate, horizontal and vertical size and position adjustments and the like. The simplified remote control 12 may have fewer buttons 16 as compared to the full-sized remote control 14.

Each of the simplified remote control 12 and the full-sized remote control 14 may use different preambles in their infrared signals 26 that they send out to the television 10. The television 10 may be designed to recognize these two different preambles to determine which user interface to activate. For example, the simplified remote control 12 may use a first preamble that is sent to the television 10 when a button 16 is pressed. This first preamble allows the television 10 to recognize that the user desires a simplified user interface. Both the simplified remote control 12 and the full-sized remote control 14 may operate using conventional technology and encoding, such as RC-5, RC-6, REC-80 or the like. Alternatively, the encoding may be proprietary in nature to the particular manufacturer of the television.

The television 10 may include buttons 22 which may allow the user various access to the user interface 24. The buttons 22 may include a reset button (not specifically shown) for returning the settings of the television 10 to default settings. The buttons 22 on the television 10 may be useful, for example, if either the simplified remote control 12 or the full-sized remote control 14 becomes lost or damaged.

As can be appreciated, the present invention may provide a television that may be manufactured as a single model in which different remotes may be used to access different levels of the television's user interface.

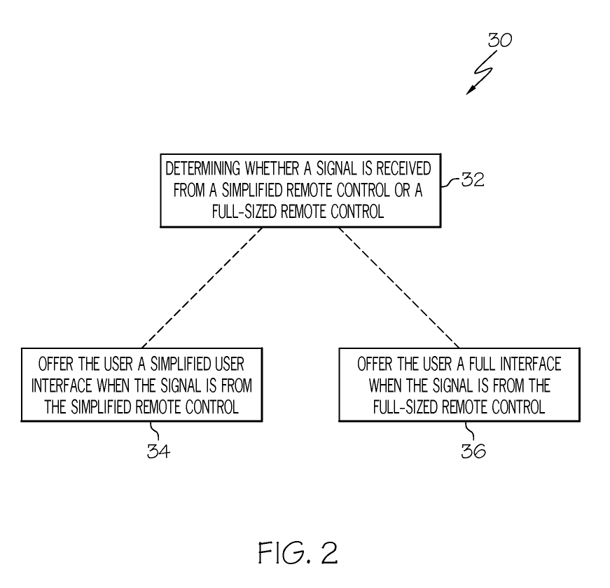

Referring to FIG. 2, the present invention may also provide a method 30 for displaying the appropriate user interface to the user. This method 30 may include a step 32 of determining whether a signal, such as a preamble, is sent by a simplified remote control or by a full-sized remote control. Based on this determination, the television may offer in the user, in a step 34, a simplified user interface when the signal is received from the simplified remote control. In an alternate step 36, the television may offer the user a full user interface when the signal is received from the full-sized remote control.

It should be understood, of course, that the foregoing relates to exemplary embodiments of the invention and that modifications may be made without departing from the spirit and scope of the invention as set forth in the following claims.

We claim:

1. An appliance comprising:
a simplified remote control for accessing a simplified user interface of the appliance; and
a full-sized remote control for accessing a full user interface of the appliance.

2. The appliance according to claim 1, wherein the appliance is selected from the group consisting of a television, a VCR, a DVD player, a DVD recorder, a surround sound system, digital cable systems, a digital television recorder, a television set-top box and a video recorder.

3. The appliance according to claim 1, wherein the appliance is a television.

4. The appliance according to claim 1, wherein the user interface is a menu system.

5. The appliance according to claim 1, wherein the simplified user interface is a menu system allowing a user to adjust limited settings of the appliance.

6. The appliance according to claim 5, wherein the limited settings include channel selection, volume, sound quality, picture brightness and picture contrast.

7. The appliance according to claim 1, wherein the full user interface is a menu system allowing a user to adjust any user adjustable setting of the appliance.

8. The appliance according to claim 1, wherein the simplified remote control has fewer buttons as compared with the full-sized remote control.

9. The appliance according to claim 1, wherein the simplified remote control includes a reset button for returning the appliance to preset default settings.

10. The appliance according to claim 1, further comprising buttons on the appliance adapted to allow a user to access the full user interface of the appliance.

11. A system for displaying a menu system to a user of an appliance, the system comprising:
a simplified remote control for accessing a simplified menu system of the appliance; and
a full-sized remote control for accessing a full menu system of the appliance.

12. The system according to claim 11, wherein the appliance is a television.

13. The system according to claim 11, wherein the simplified remote control sends a first preamble to the appliance, thereby allowing the user to access the simplified menu system.

14. The system according to claim 13, wherein the full-sized remote control sends a second preamble to the appliance different from the first preamble that the simplified remote control sends to the appliance, thereby allowing the user to access the full menu system.

15. The system according to claim 11, wherein the simplified remote control includes a reset button for returning the television to preset default settings.

16. An appliance responsive to a first remote control preamble and a second remote control preamble, said first and second remote control preambles determining a user interface of the appliance.

17. The appliance according to claim 16 wherein:
the first remote control preamble is sent from a simplified remote control for accessing a simplified menu system of the appliance; and
the second remote control preamble is sent from a full-sized remote control for accessing a full menu system of the appliance.

18. A method for displaying an appropriate user interface to a user of an appliance, the method comprising:
determining whether a signal is received from a simplified remote control or from a full-sized remote control;
offering the user a simplified user interface when the signal is received from the simplified remote control; and
offering the user a full user interface when the signal is received from the full-sized remote control.

19. The method according to claim 18, wherein the appliance is a television.

20. The method according to claim 18, wherein:
the simplified user interface is a menu system allowing a user to adjust limited settings of the appliance; and
wherein the full user interface is a menu system allowing a user to adjust any user adjustable setting of the appliance.
